(19) United States
(12) Patent Application Publication
(10) Pub. No.: US 2019/0335153 A1
(43) Pub. Date: Oct. 31, 2019

(54) METHOD FOR MULTI-CAMERA DEVICE

(71) Applicant: Nokia Technologies Oy, Espoo (FI)

(72) Inventor: Payman AFLAKI BENI, Tampere (FI)

(21) Appl. No.: 16/347,652

(22) PCT Filed: Nov. 2, 2017
(86) PCT No.: PCT/FI2017/050757

§ 371 Date: May 6, 2019

(30) Foreign Application Priority Data
Nov. 17, 2016 (GB) 1619428.4

(51) Int. Cl. H04N 13/117; H04N 13/243

(52) U.S. Cl. CPC H04N 13/117; H04N 13/161; H04N 13/243

(57) ABSTRACT

The invention relates to a method and apparatus for implementing the method. The method comprises receiving media content from a multicamera capturing device, the media content comprising stereoscopic and monoscopic areas; determining a plurality of preliminary most probable viewing directions from the received media content; creating an ordered list of the plurality of preliminary most probable viewing directions; determining a highest ranked preliminary most probable viewing direction in the ordered list of the plurality of preliminary most probable viewing directions that is in the stereoscopic area; and setting such preliminary most probable viewing direction to be a final most probable viewing direction.

### TECHNICAL FIELD

The present solution generally relates to processing media content. In particular, the solution relates to a multi-camera imaging, and determining the most probable viewing direction in 360 degree image.

### BACKGROUND

Digital stereo viewing has become commonplace, and equipment for viewing 3D (three-dimensional) media content is more widely available. Theatres are offering 3D movies based on viewing the movie with special glasses that ensure the viewing of different images for the left and right eye for each frame of the movie. The same approach has been brought to home use with 3D-capable players, e.g. head-mounted displays, and television sets for playing 3D media content.

Devices able to capture 3D media content are also becoming popular. An example of such device is a multicamera capturing device comprising a plurality of cameras.

### SUMMARY

Now there has been invented an improved method and technical equipment implementing the method, for determining the most probable viewing direction on a three-dimensional media content. Various aspects of the invention include a method, an apparatus and a computer readable medium comprising a computer program stored therein, which are characterized by what is stated in the independent claims. Various embodiments of the invention are disclosed in the dependent claims.

According to a first aspect, there is provided a method comprising receiving media content from a multicamera capturing device, the media content comprising stereoscopic and monoscopic areas; determining a plurality of preliminary most probable viewing directions from the received media content; creating an ordered list of the plurality of preliminary most probable viewing directions; determining a highest ranked preliminary most probable viewing direction in the ordered list of the plurality of preliminary most probable viewing directions that is in the stereoscopic area; and setting such preliminary most probable viewing direction to be a final most probable viewing direction.

According to an embodiment, the method comprises determining the highest ranked preliminary most probable viewing direction that is in the stereoscopic area by
a) setting a top ranked preliminary most probable viewing direction to be a current most probable viewing direction;
b) determining is the current most probable viewing direction in the stereoscopic area; and if not
c) setting next ranked preliminary most probable viewing direction in the list to be the current most probable viewing direction, and proceeding to step b).

According to an embodiment, the preliminary most probable viewing directions are determined by means of one or more of the following: direction of eye gazes, user inputs, content provider inputs.

According to an embodiment, the ordered list of the plurality of preliminary most probable viewing directions comprises updated most probable viewing directions.

According to an embodiment, the updated most probable viewing directions are determined by using information on the direction of the multicamera capturing device.

According to an embodiment, the stereoscopic area is covered at least by two cameras of the multicamera capturing device.

According to a second aspect, there is provided an apparatus comprising at least one processor, memory including computer program code, the memory and the computer program code configured to, with the at least one processor, cause the apparatus to perform at least the following: to receive media content from a multicamera capturing device, the media content comprising stereoscopic and monoscopic areas; to determine a plurality of preliminary most probable viewing directions from the received media content; to create an ordered list of the plurality of preliminary most probable viewing directions; to determine a highest ranked preliminary most probable viewing direction in the ordered list of the plurality of preliminary most probable viewing directions that is in the stereoscopic area; and to set such preliminary most probable viewing direction to be a final most probable viewing direction.

According to an embodiment, the apparatus further comprises computer program code configured to cause the apparatus to determine the highest ranked preliminary most probable viewing direction that is in the stereoscopic area by
a) setting a top ranked preliminary most probable viewing direction to be a current most probable viewing direction;
b) determining is the current most probable viewing direction in the stereoscopic area; and if not
c) setting next ranked preliminary most probable viewing direction in the list to be the current most probable viewing direction, and proceeding to step b).

According to an embodiment, the preliminary most probable viewing directions are determined by means of one or more of the following: direction of eye gazes, user inputs, content provider inputs.

According to an embodiment, the ordered list of the plurality of preliminary most probable viewing directions comprises updated most probable viewing directions.

According to an embodiment, the updated most probable viewing directions are determined by using information on the direction of the multicamera capturing device.

According to an embodiment, the stereoscopic area is covered at least by two cameras of the multicamera capturing device.

According to a third aspect, there is provided an apparatus comprising means for receiving media content from a multicamera capturing device, the media content comprising stereoscopic and monoscopic areas; means for determining a plurality of preliminary most probable viewing directions from the received media content; means for creating an ordered list of the plurality of preliminary most probable viewing directions; means for determining a highest ranked preliminary most probable viewing direction in the ordered list of the plurality of preliminary most probable viewing directions that is in the stereoscopic area; and means for setting such preliminary most probable viewing direction to be a final most probable viewing direction.

According to an embodiment, the apparatus further comprises means for determining the highest ranked preliminary most probable viewing direction that is in the stereoscopic area by
a) setting a top ranked preliminary most probable viewing direction to be a current most probable viewing direction;
b) determining is the current most probable viewing direction in the stereoscopic area; and if not
c) setting next ranked preliminary most probable viewing direction in the list to be the current most probable viewing direction, and proceeding to step b).

According to an embodiment, the ordered list of the plurality of preliminary most probable viewing directions comprises updated most probable viewing directions.

According to an embodiment, the apparatus further comprises means for determining the updated most probable viewing directions by using information on the direction of the multicamera capturing device.

According to a fourth aspect, there is provided a computer program product embodied on a non-transitory computer readable medium, comprising computer program code configured to, when executed on at least one processor, cause an apparatus or a system to receive media content from a multicamera capturing device, the media content comprising stereoscopic and monoscopic areas; to determine a plurality of preliminary most probable viewing directions from the received media content; to create an ordered list of the plurality of preliminary most probable viewing directions; to determine a highest ranked preliminary most probable viewing direction in the ordered list of the plurality of preliminary most probable viewing directions that is in the stereoscopic area; and to set such preliminary most probable viewing direction to be a final most probable viewing direction.

According to an embodiment, the computer program product further comprises computer program code configured to determine the highest ranked preliminary most probable viewing direction that is in the stereoscopic area by
a) setting a top ranked preliminary most probable viewing direction to be a current most probable viewing direction;
b) determining is the current most probable viewing direction in the stereoscopic area; and if not
c) setting next ranked preliminary most probable viewing direction in the list to be the current most probable viewing direction, and proceeding to step b).

According to an embodiment, the ordered list of the plurality of preliminary most probable viewing directions comprises updated most probable viewing directions.

According to an embodiment, the computer program product further comprises computer program code configured to determine the updated most probable viewing directions by using information on the direction of the multicamera capturing device.

### DESCRIPTION OF THE DRAWINGS

In the following, various embodiments of the invention will be described in more detail with reference to the appended drawings, in which

FIG. 1 shows a system and apparatuses for stereo viewing;

FIG. 2a shows a camera device for stereo viewing;

FIG. 2b shows a head-mounted display for stereo viewing;

FIG. 3 shows a camera according to an embodiment;

FIGS. 4a, b show examples of a multicamera capturing device;

FIGS. 5a, b show an encoder and a decoder according to an embodiment;

FIG. 6 shows an example of multicamera direction and two dimensional and three dimensional captured areas;

FIG. 7 is a flowchart of a method according to an embodiment;

FIG. 8 is a flowchart of a method according to another embodiment; and

FIG. 9 shows an apparatus according to an embodiment as a simplified block chart.

### DESCRIPTION OF EXAMPLE EMBODIMENTS

The present embodiments are discussed in relation to a content captured with a multicamera capturing device. A multicamera capturing device comprises two or more cameras, wherein the two or more cameras may be arranged in pairs in said multicamera capturing device. Each said camera has a respective field of view, and each said field of view covers the view direction of the multicamera capturing device.

In particular, the present embodiments are targeted to a solution for selecting the most probable viewing direction (MPVD) based on multicamera structure/parameters and eye gaze of users watching content.

The multicamera capturing device may comprise cameras at locations corresponding to at least some of the eye positions of a human head at normal anatomical posture, eye positions of the human head at maximum flexion anatomical posture, eye positions of the human head at maximum extension anatomical postures, and/or eye positions of the human head at maximum left and right rotation anatomical postures. The multicamera capturing device may comprise at least three cameras, the cameras being disposed such that their optical axes in the direction of the respective camera's field of view fall within a hemispheric field of view, the multicamera capturing device comprising no cameras having their optical axes outside the hemispheric field of view, and the multicamera capturing device having a total field of view covering a full sphere.

The multicamera capturing device described here may have cameras with wide-angle lenses. The multicamera capturing device may be suitable for creating stereo viewing image data and/or multiview video, comprising a plurality of video sequences for the plurality of cameras. The multicamera may be such that any pair of cameras of the at least two cameras has a parallax corresponding to parallax (disparity) of human eyes for creating a stereo image. At least two cameras may have overlapping fields of view such that an overlap region for which every part is captured by said at least two cameras is defined, and such overlap area can be used in forming the image for stereo viewing.

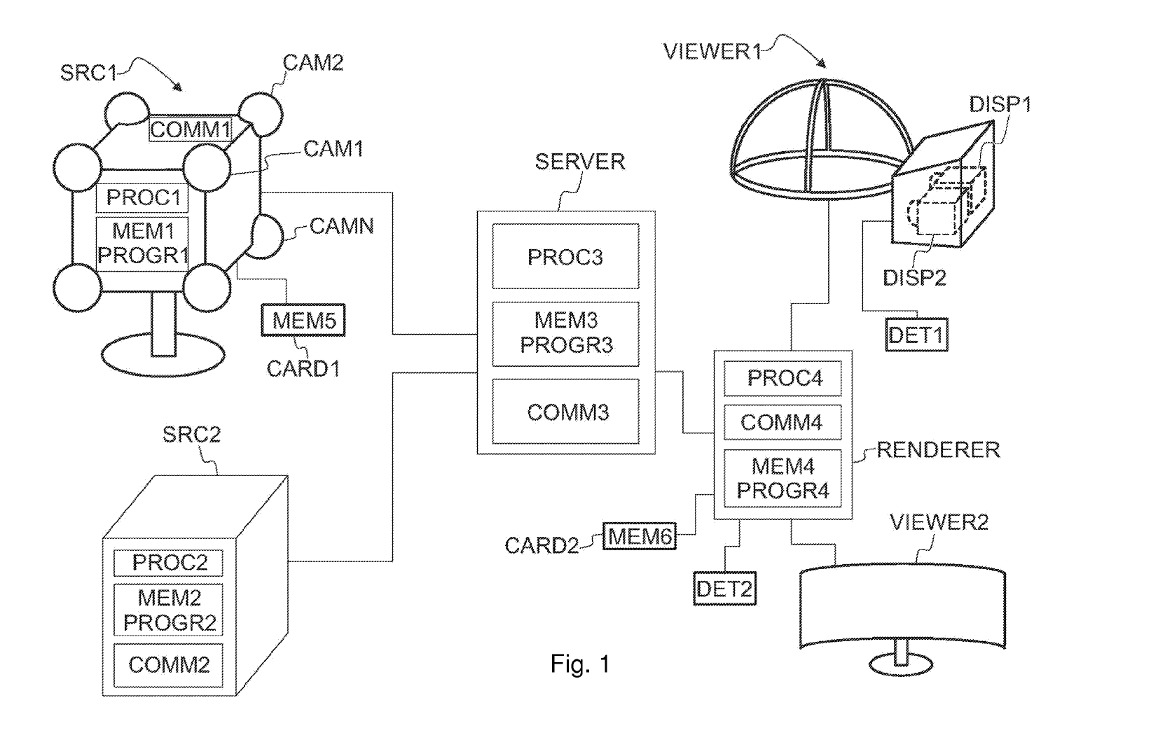

FIG. 1 shows a system and apparatuses for stereo viewing, that is, for 3D video and 3D audio digital capture and playback. The task of the system is that of capturing sufficient visual and auditory information from a specific location such that a convincing reproduction of the experience, or presence, of being in that location can be achieved by one or more viewers physically located in different locations and optionally at a time later in the future. Such reproduction requires more information that can be captured by a single camera or microphone, in order that a viewer can determine the distance and location of objects within the scene using their eyes and their ears. To create a pair of images with disparity, two camera sources are used.

In a similar manner, for the human auditory system to be able to sense the direction of sound, at least two microphones are used (the commonly known stereo sound is created by recording two audio channels). The human auditory system can detect the cues, e.g. in timing difference of the audio signals to detect the direction of sound.

The system of FIG. 1 may consist of three main parts: image sources, a server and a rendering device. A video capture device SRC1 comprises multiple cameras CAM1, CAM2, . . . , CAMN with overlapping field of view so that regions of the view around the video capture device is captured from at least two cameras. The device SRC1 may comprise multiple microphones to capture the timing and phase differences of audio originating from different directions. The device SRC1 may comprise a high resolution orientation sensor so that the orientation (direction of view) of the plurality of cameras can be detected and recorded. The device SRC1 comprises or is functionally connected to a computer processor PROC1 and memory MEM1, the memory comprising computer program PROGR1 code for controlling the video capture device. The image stream captured by the video capture device may be stored on a memory device MEM2 for use in another device, e.g. a viewer, and/or transmitted to a server using a communication interface COMM1. It needs to be understood that although an 8-camera-cubical setup is described here as part of the system, another multicamera (e.g. a stereo camera) device may be used instead as part of the system.

Alternatively or in addition to the video capture device SRC1 creating an image stream, or a plurality of such, one or more sources SRC2 of synthetic images may be present in the system. Such sources of synthetic images may use a computer model of a virtual world to compute the various image streams it transmits. For example, the source SRC2 may compute N video streams corresponding to N virtual cameras located at a virtual viewing position. When such a synthetic set of video streams is used for viewing, the viewer may see a three-dimensional virtual world.

The device SRC2 comprises or is functionally connected to a computer processor PROC2 and memory MEM2, the memory comprising computer program PROGR2 code for controlling the synthetic sources device SRC2. The image stream captured by the device may be stored on a memory device MEM5 (e.g. memory card CARD1) for use in another device, e.g. a viewer, or transmitted to a server or the viewer using a communication interface COMM2.

There may be a storage, processing and data stream serving network in addition to the capture device SRC1. For example, there may be a server SERVER or a plurality of servers storing the output from the capture device SRC1 or computation device SRC2. The device SERVER comprises or is functionally connected to a computer processor PROC3 and memory MEM3, the memory comprising computer program PROGR3 code for controlling the server. The device SERVER may be connected by a wired or wireless network connection, or both, to sources SRC1 and/or SRC2, as well as the viewer devices VIEWER1 and VIEWER2 over the communication interface COMM3.

For viewing the captured or created video content, there may be one or more viewer devices VIEWER1 and VIEWER2. These devices may have a rendering module and a display module, or these functionalities may be combined in a single device. The devices may comprise or be functionally connected to a computer processor PROC4 and memory MEM4, the memory comprising computer program PROG4 code for controlling the viewing devices. The viewer (playback) devices may consist of a data stream receiver for receiving a video data stream from a server and for decoding the video data stream. The data stream may be received over a network connection through communications interface COMM4, or from a memory device MEM6 like a memory card CARD2. The viewer devices may have a graphics processing unit for processing of the data to a suitable format for viewing. The viewer VIEWER1 comprises a high-resolution stereo-image head-mounted display for viewing the rendered stereo video sequence. The head-mounted display may have an orientation sensor DET1 and stereo audio headphones. The viewer VIEWER2 comprises a display enable with 3D technology (for displaying stereo video), and the rendering device may have a head-orientation detector DET2 connected to it. Any of the devices (SRC1, SRC2, SERVER, RENDERER, VIEWER1, VIEWER2) may be a computer or a portable computing device, or be connected to such. Such rendering devices may have computer program code for carrying out methods according to various examples described in this text.

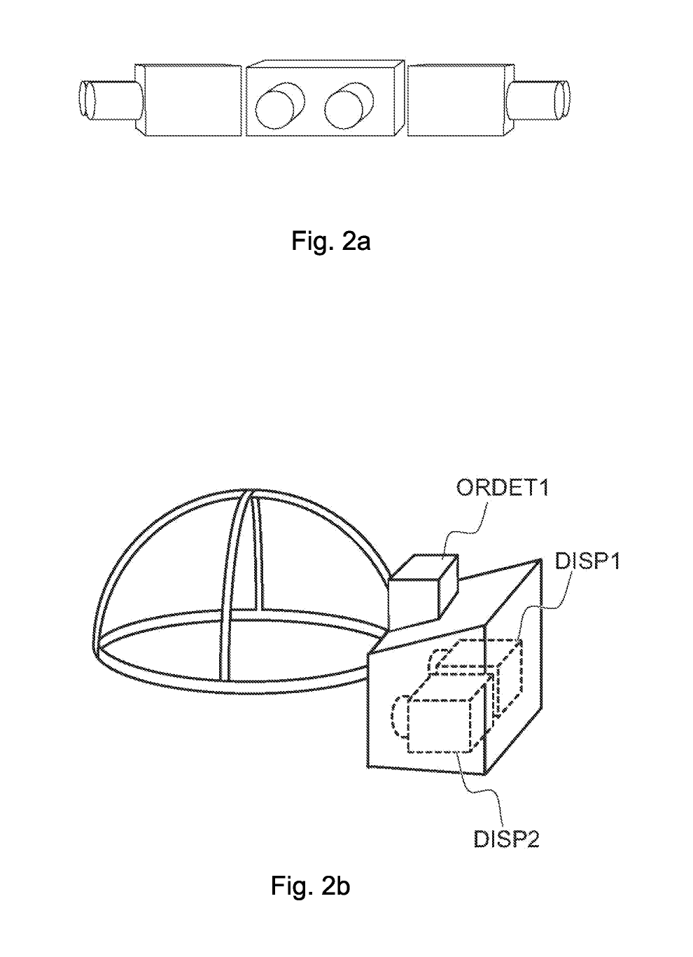

FIG. 2a shows a camera device for stereo viewing. The camera comprises two or more cameras that are configured into camera pairs for creating the left and right eye images, or that can be arranged to such pairs. The distances between cameras may correspond to the usual (or average) distance between the human eyes. The cameras may be arranged so that they have significant overlap in their field-of-view. For example, wide-angle lenses of 180-degrees or more may be used, and there may be 2, 3, 4, 5, 6, 7, 8, 9, 10, 12, 16, or 20 cameras. The cameras may be regularly or irregularly spaced to access the whole sphere of view, or they may cover only part of the whole sphere. For example, there may be three cameras arranged in a triangle and having different directions of view towards one side of the triangle such that all three cameras cover an overlap area in the middle of the directions of view. As another example, 8 cameras having wide-angle lenses and arranged regularly at the corners of a virtual cube and covering the whole sphere such that the whole or essentially whole sphere is covered at all directions by at least 3 or 4 cameras. In FIG. 2a three stereo camera pairs are shown.

Multicamera capturing devices with other types of camera layouts may be used. For example, a camera device with all cameras in one hemisphere may be used. The number of cameras may be e.g., 2, 3, 4, 6, 8, 12, or more. The cameras may be placed to create a central field of view where stereo images can be formed from image data of two or more cameras, and a peripheral (extreme) field of view where one camera covers the scene and only a normal non-stereo image can be formed.

FIG. 2b shows a head-mounted display for stereo viewing. The head-mounted display is a device worn by a user to give a 3D perception of the recorded/streamed content. Head-mounted displays gives a virtual filling or presence in the scene where the video had been recorded as the stereoscopic video pair shown to the user vary based on the head movement of the user. The head-mounted display comprises two screen sections or two screens DISP1 and DISP2 for displaying the left and right eye images. The displays are close to the eyes, and therefore lenses are used to make the images easily viewable and for spreading the images to cover as much as possible of the eyes' field of view. The device is attached to the head of the user so that it stays in place even when the user turns his head. The device may have an orientation detecting module ORDET1 for determining the head movements and direction of the head. The head-mounted display gives a three-dimensional (3D) perception of the recorded/streamed content to a user.

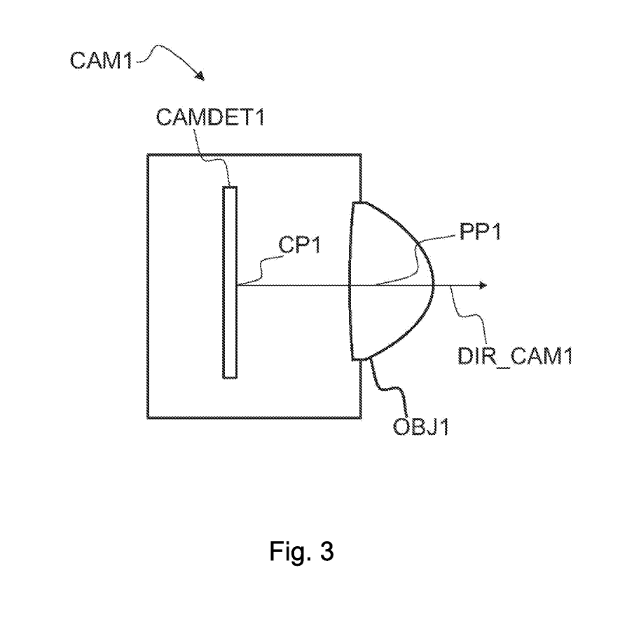

FIG. 3 illustrates a camera CAM1. The camera has a camera detector CAMDET1, comprising a plurality of sensor elements for sensing intensity of the light hitting the sensor element. The camera has a lens OBJ1 (or a lens arrangement of a plurality of lenses), the lens being positioned so that the light hitting the sensor elements travels through the lens to the sensor elements. The camera detector CAMDET1 has a nominal center point CP1 that is a middle point of the plurality of sensor elements, for example for a rectangular sensor the crossing point of the diagonals. The lens has a nominal center point PP1, as well, lying for example on the axis of symmetry of the lens. The direction of orientation of the camera is defined by the line passing through the center point CP1 of the camera sensor and the center point PP1 of the lens. The direction of the camera is a vector along this line pointing in the direction from the camera sensor to the lens. The optical axis of the camera is understood to be this line CP1-PP1.

The system described above may function as follows. Time-synchronized video, audio and orientation data is first recorded with the capture device. This can consists of multiple concurrent video and audio streams as described above. The video and audio streams are then transmitted immediately or later to the storage and processing network for processing and conversion into a format suitable for subsequent delivery to playback devices. The conversion can involve post-processing steps to the audio and video data in order to improve the quality and/or reduce the quantity of the data while preserving the quality at a desired level. Finally, each playback device receives a stream of the data from the network, and renders it into a stereo viewing reproduction of the original location which can be experienced by a user with the head-mounted display and headphones.

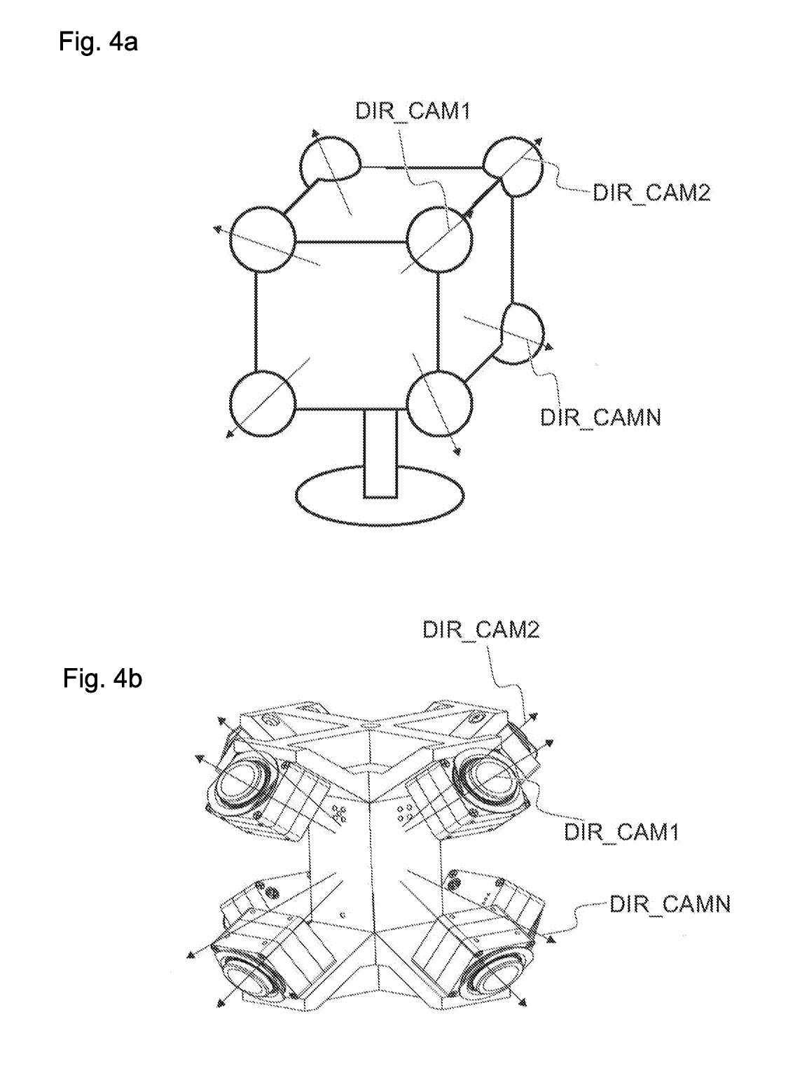

FIGS. 4a and 4b show an example of a camera device for being used as an image source. To create a full 360 degree stereo panorama every direction of view needs to be photographed from two locations, one for the left eye and one for the right eye. In case of video panorama, these images need to be shot simultaneously to keep the eyes in sync with each other. As one camera cannot physically cover the whole 360 degree view, at least without being obscured by another camera, there need to be multiple cameras to form the whole 360 degree panorama. Additional cameras however increase the cost and size of the system and add more data streams to be processed. This problem becomes even more significant when mounting cameras on a sphere or platonic solid shaped arrangement to get more vertical field of view. However, even by arranging multiple camera pairs on for example a sphere or platonic solid such as octahedron or dodecahedron, the camera pairs will not achieve free angle parallax between the eye views. The parallax between eyes is fixed to the positions of the individual cameras in a pair, that is, in the perpendicular direction to the camera pair, no parallax can be achieved. This is problematic when the stereo content is viewed with a head mounted display that allows free rotation of the viewing angle around z-axis as well.

The requirement for multiple cameras covering every point around the capture device twice would require a very large number of cameras in the capture device.

In this technique lenses are used with a field of view of 180 degree (hemisphere) or greater, and the cameras are arranged with a carefully selected arrangement around the capture device. Such an arrangement is shown in FIG. 4a, where the cameras have been positioned at the corners of a virtual cube, having orientations DIR_CAM1, DIR_CAM2, . . . , DIR_CAMN pointing away from the center point of the cube. Naturally, other shapes, e.g. the shape of a cuboctahedron, or other arrangement, even irregular ones, can be used.

Overlapping super wide field of view lenses may be used so that a camera can serve both as the left eye view of a camera pair and as the right eye view of another camera pair. This reduces the amount of needed cameras to half. Reducing the number of cameras in this manner increases the stereo viewing quality, because it also allows picking the left eye and right eye cameras arbitrarily among all the cameras as long as they have enough overlapping view with each other. Using this technique with different number of cameras and different camera arrangements such as sphere and platonic solids enables picking the closest matching camera for each eye achieving also vertical parallax between the eyes. This is beneficial especially when the content is viewed using head mounted display. The described camera setup may allow creating stereo viewing with higher fidelity and smaller expenses of the camera device.

In the related technology, a technique called eye gaze tracking is known. Eye gaze tracking is a process of measuring either the point of gaze (i.e. where on is looking) or the motion of an eye relative to the head. An eye gaze tracker is a device for measuring eye positions and eye movement, and to follow the movement of eye's pupil to figure out exactly to which point the user is looking at. Eye gaze trackers are used in research on the visual systems and subjective tests enabling researchers to follow the eye movement of users considering different content presented. Eye gaze can for example be tracked using a camera tracking the movement of pupil in user's eye. The process can be done in real time and with a relatively low processing and resources required.

An algorithm proposed by Laurent in publication “Automatic foveation for video compression using a neurobiological model of visual attention” (2004) can be used for predicting the eye gaze based on the characteristics of the content. The proposed process requires a considerable amount of operations per pixel and hence cannot be utilized in most of the handheld devices due to the extensive power consumption.

The present embodiments relate to determining the most probable viewing direction (MPVD) in a 360 degree image. In the related technology, the MPVD can be determined based on subject's head movement or eye gaze direction. This can be averaged over several subjects watching the same content. Alternatively, the MPVD can be determined based on the amount of movement in the scene (i.e. the pixel with highest spatial location movement along a specific period of time or a specific number of frames, e.g. one GOP (group of pictures)). The MPVD can also be determined based on the depth information and closeness of the pixels to the viewer, or the MPVD can be provided by the content provider and alongside the content. MPVD can also be defined based on the preference of users separately. For example, if users define their preference on a specific object e.g. a plane or a dog, then those parts of the scene are prioritized and hence, the MPVD can be modified accordingly to better cover the objects of preference for those users. It is to be noticed that any combination of the previous methods can also be used for determining the MPVD.

The present solution can be utilized in a situation, where a cameraman (i.e. the person capturing image frames by the camera device) is capturing a scene with a (either moving or stationary) multicamera capturing device. The captured part of the scene is called “content” in this application. The content captured by the multicamera capturing device may include N views, for example 8 views, that are stitched together to generate a 360 degree image.

In such content, according to a present solution, the MPVD may be selected by using information on the eye gaze of the users, and alternatively also on the multicamera structure, and intrinsic and extrinsic parameters of individual camera devices (e.g. DIRCAM1, DIRCAM2, . . . , DIRCAMN shown in FIGS. 4a, 4b) of the multicamera system.

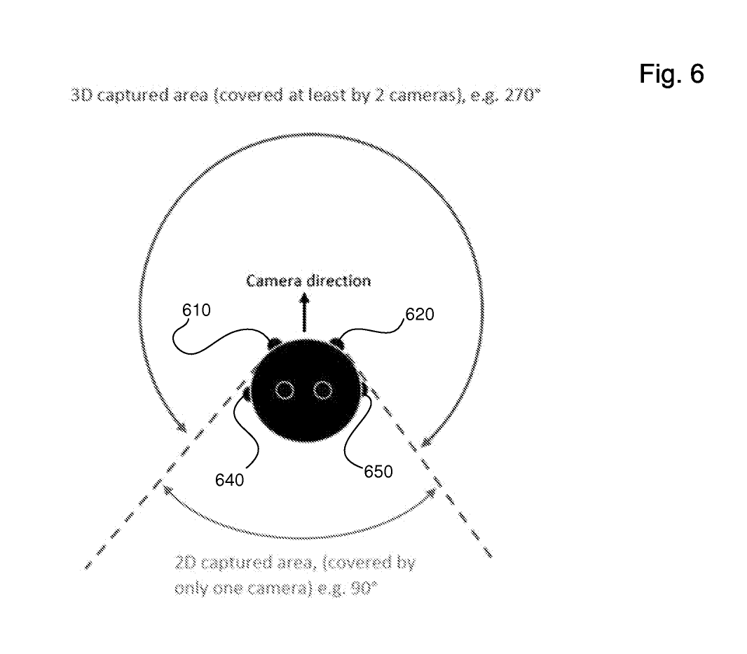

The multicamera capturing device capturing the scene in 3D has a main capturing direction. Towards this direction, the content is captured in 3D and on the opposite direction and around it the content is not captured or captured only in 2D. The 3D area is covered by at least two cameras, while the 2D area is covered only by one camera. The 3D covered area means that a stereoscopic presentation is available for those areas while the 2D covered area means that a monoscopic presentation is available. This is illustrated in FIG. 6, where the camera direction, and the two-dimensional and three-dimensional capturing areas are clarified. It should be noticed that the 3D capturing area is expected to be larger than the 2D capturing area, since it is one of the main features of the multicamera capturing device. The direction and size of the 2D and 3D capturing zones are defined based on the extrinsic and intrinsic parameters of individual cameras in the multicamera capturing device as well as the whole setup and characteristics of the device. It should be noted that the multicamera capturing devices are used to capture the panoramic (360 degree) view and hence, at least one view per direction should be available. However, since not all areas are covered by more than one camera, there exists some parts, located in the opposite of camera direction of the multicamera capturing device (as depicted in FIG. 6), which are only covered by one of the extreme left or right cameras (630, 640) and hence, there is no stereoscopic content available for 3D presentation of that area.

Therefore, the present embodiments propose to consider the eye gaze of users with or without the structure of the multicamera capturing device to decide what the MPVD should be. The structure of the device may be added to this determination because users can be distracted from the scene for several reasons, e.g. they want to explore the three-dimensional presentation of the content with the head-mounted display. It is quite normal for the users to turn around and see what is happening behind them. This will contribute to selecting the MPVD in a direction which has not been the target direction of the cameraman and content provider in general. Alternatively, the users can be distracted because they want to make sure if the opposite direction (compared to the direction of the camera device) is also available or not. This will contribute to selecting a preliminary MPVD which might be suboptimal from the content provider point of view due to lack of depth perception for the users. In other words, the preliminary MPVD selected based on the eye gaze of the users may point to a location which has been captured in 2D as opposed to the locations which has been captured in 3D. Such direction may not be the target direction of the cameraman and hence, should be corrected in order to put the final

MPVD in a direction where users achieve the best experience out of the current content. The users may also be distracted because of their personal point of interests, which is not aligned with the MPVD aimed by the cameraman. For example, some people may have some personal point of interest in the field, e.g. a special type of dog or car, a special location, etc. Sometimes, the users may be distracted because of the content provider does not want the selected MPVD to be in the 2D covered areas as that will nullify the depth perception of the users and settles an unsatisfactory experience to the users.

Such a distraction will result in an inaccurate MPVD in some cases. Therefore, by taking into account the structure of the device, the found MPVD based on the eye gaze can be modified to make sure that it is also aligned with the device structure. Such an alignment includes limiting the MPVD in the 3D capturing areas. This means that if the preliminary MPVD is directing to a direction inside the 2D captured areas, then the preliminary MPVD should be modified to keep the final MPVD inside the 3D captured areas. This is also of interest of the content provider, as they do not want the users to watch (or be directed to watch) the content which has been captured with only one single camera (compared to stereoscopic content), as this will reduce the user experience and hence, the wow effect of the device/content may be affected negatively.

In practice, the method according to an embodiment comprises determining all the potential MPVDs (i.e. preliminary MPVDs) from the media content by using different methods. The media content has been received and/or captured from a multicamera capturing device and stored. The media content may comprise stereoscopic and monoscopic covered areas. The used methods may be already known from related technology or may be part of the future technology. The preliminary MPVDs are ranked and put in a list. The preliminary MPVDs are gone through one by one by taking into account at least the eye gaze, and alternatively also the structure of the multicamera capturing device. If a preliminary MPVD is inside the 3D captured area, then that MPVD is selected as the final MPVD, otherwise (i.e. a preliminary MPVD under consideration is in the 2D covered area) the next preliminary MPVD candidate in the candidate list is taken and tested whether it is inside the 3D captured area.

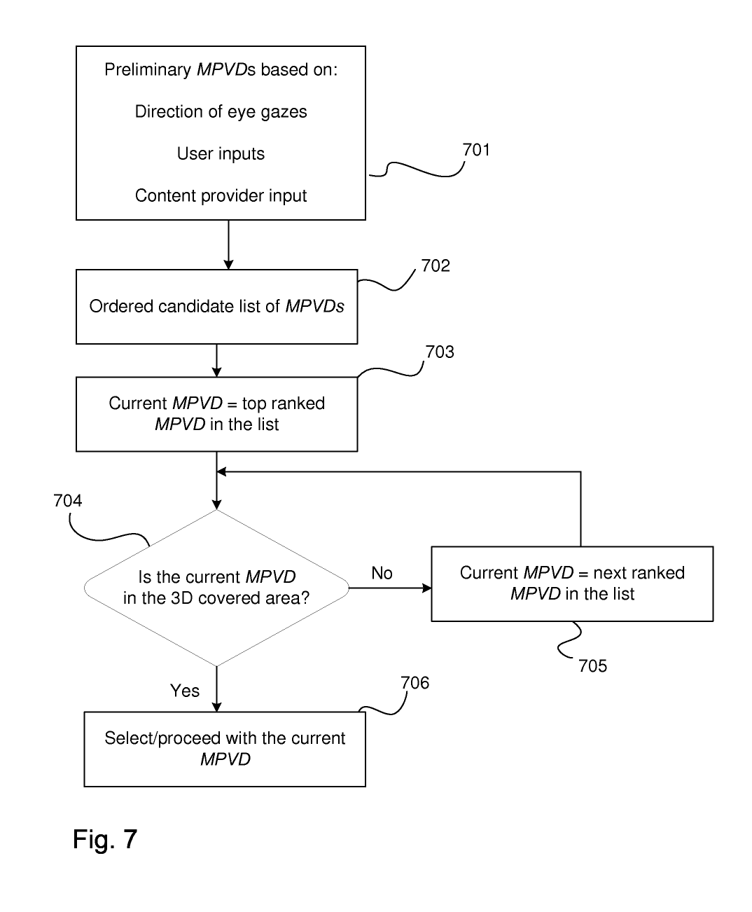

It is realized, that in the method the MPVD candidate consideration is repeated until a preliminary MPVD inside the 3D covered area is found. The method according to an embodiment is shown in a flowchart of FIG. 7.

This embodiment begins by determining a selection of preliminary candidate MPVDs according to the direction of eye gazes of different users, user inputs, and content provider inputs 701. A list of preliminary MPVDs is created 702, wherein a top ranked preliminary MPVD in the list 703 is set as the current MPVD. Such ranking may be based on different inputs e.g. the user preference, eye gaze concentration on more than one direction. For example, if a user has defined dog as an interesting object in the scene, then the MPVDs including the dog are ranked higher than the rest of the MPVDs. Alternatively, if there are three MPVDs found based on the eye gaze of the users, then they are ranked based on the number of users who have contributed to selecting each direction. In a step 704, it is tested whether the current MPVD is in the 3D covered area. If not, the current MPVD is set to be the next ranked preliminary MPVD in the list. Steps 704 and 705 are repeated until, the current MPVD is in the 3D covered area, and such MPVD is selected as final MPVD and proceeded with.

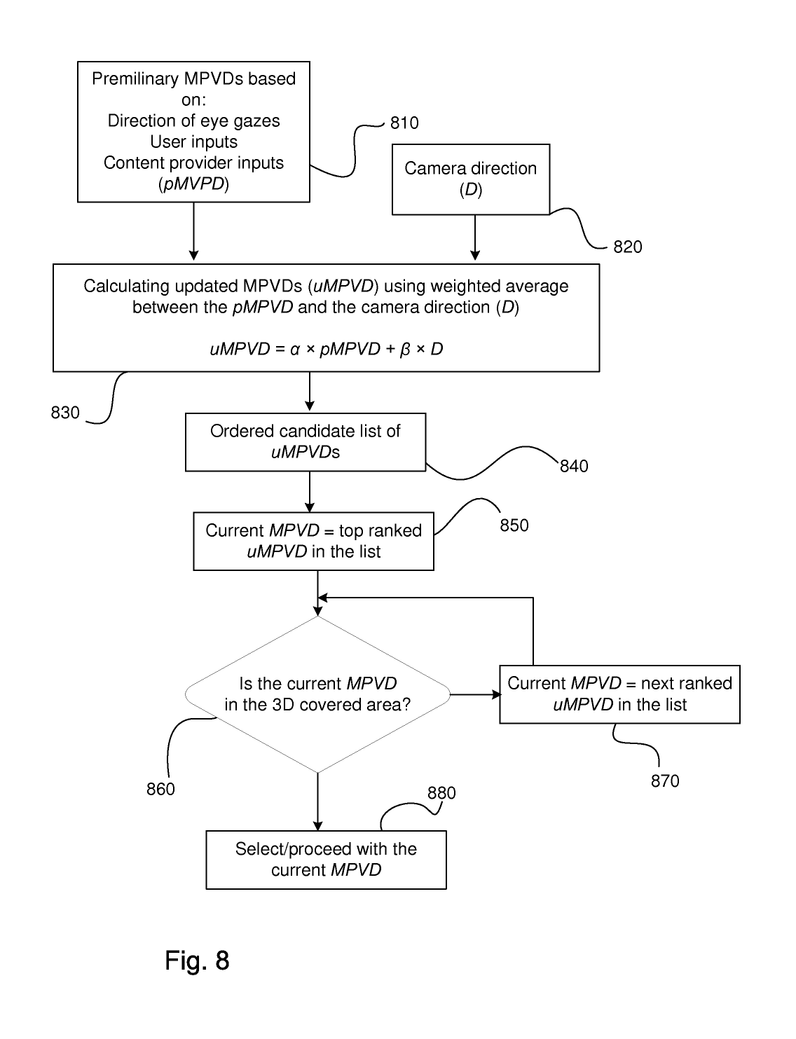

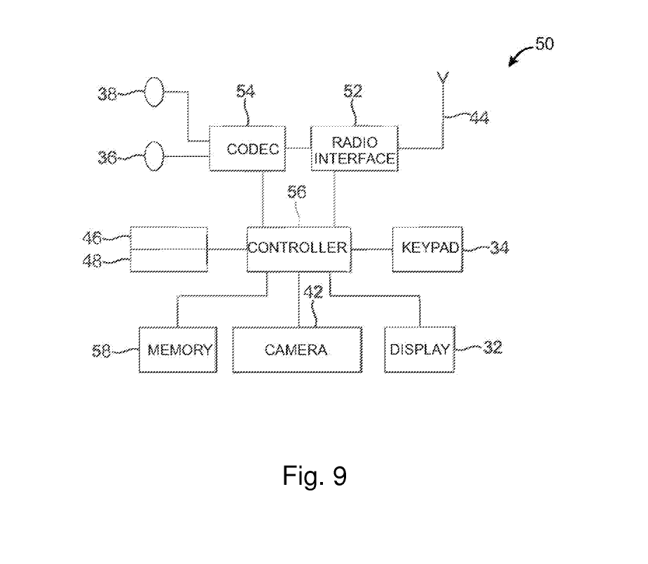

The camera direction may also contribute to the selection of MPVD with the eye gaze data gathered from different users. According to another embodiment, shown in FIG. 8, the direction of the eye gazes, user inputs, content provider inputs, but also the camera direction are taken into account to define the final MPVD. This embodiment will use weighting parameters to update the value of a series of preliminary MPVDs (pMPVD) defined based on the direction of eye gazes, user inputs, and content provider inputs, based on the camera direction. The selection of weighting parameters depends on how accurately the cameraman has been able to align the camera direction and the correct MPVD. The better the adjustment, the higher the weight of the camera direction.

The method according to an embodiment and shown in FIG. 8 comprises determining the direction of eye gazes of different users, user inputs, and content provider inputs (pMPVD) 810 and camera direction (D) 820. By using this information, the method proceeds to calculating 830 an updated most probable viewing directions uMPVD using weighted average between the pMPVD and the camera direction. The updated direction uMPVD=α×pMPVD+β×D, where α, β are the weighting parameters to further bias the uMPVD towards either pMPVD or D, where 0≤α, β≤1 and α+β=1. For example values α=0.4 and β=0.6 define that the contribution of camera direction is more important compared to the tracked eye gaze direction of the users. After calculation, a list of candidate updated MPVDs is created 840. A candidate MPVD under consideration is the top ranked uMPVD in the list 850, and such candidate uMPVD is set at first as the current MPVD. In step 860 it is tested whether the current MPVD is in the 3D covered area. If not, the current MPVD is set to be the next ranked uMPVD in the list 870. Steps 860 and 870 are repeated until, the current MPVD is in the 3D covered area, and such MPVD is selected to be the final MPVD and proceeded with 880.

It should be noticed that any other embodiment or combination of eye gaze direction, multicamera capturing device direction, or user/content creator input parameters can be used to rank the available MPVDs. The key contribution of the present embodiments is to select the highest ranked MPVD which is still inside the 3D captured areas (in other words, a stereoscopic presentation is available for that direction).

The user inputs may comprise defining a preferred object such as a dog or plane. Following this, the preliminary MPVDs are first selected and then ranked taking into account such user preference. Similarly, user can mention the objects of least interest where for example the MPVDs including those objects (found based on the eye gaze of users) are ranked lower relatively.

The content provider/creator inputs may include a specific feature in the scene e.g. a set of fireworks or a famous person entering to the scene. This may not always be the same as the camera direction and the content provider can point it out by adding the “content provider inputs” to be used in selecting the preliminary MPVDs.

An embodiment of an apparatus is illustrated in FIGS. 12. The apparatus 50 may comprise a housing for incorporating and protecting the device. The apparatus 50 may further comprise a display 32 in the form of a liquid crystal display. In other embodiments of the invention the display may be any suitable display technology suitable to display an image 30 or video. The apparatus 50 may further comprise a keypad 34. In other embodiments of the invention any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise a camera 42 capable of recording or capturing images and/or video. The camera 42 is a multicamera having at least two cameras. The camera is capable of recording or detecting individual frames which are then passed to the codec 54 or the controller for processing. The apparatus may receive the video and/or image data for processing from another device prior to transmission and/or storage.

The apparatus 50 may further comprise an infrared port for short range line of sight communication to other devices. According to an embodiment, the apparatus may further comprise any suitable short range communication solution such as for example a Bluetooth wireless connection or a USB (Universal Serial Bus)/firewire wired connection.

The apparatus 50 may comprise a controller 56 or processor for controlling the apparatus 50. The controller 56 may be connected to memory 58 which may store data in the form of image, video and/or audio data, and/or may also store instructions for implementation on the controller 56. The controller 56 may further be connected to codec circuitry 54 suitable for carrying out coding and decoding of image, video and/or audio data or assisting in coding and decoding carried out by the controller.

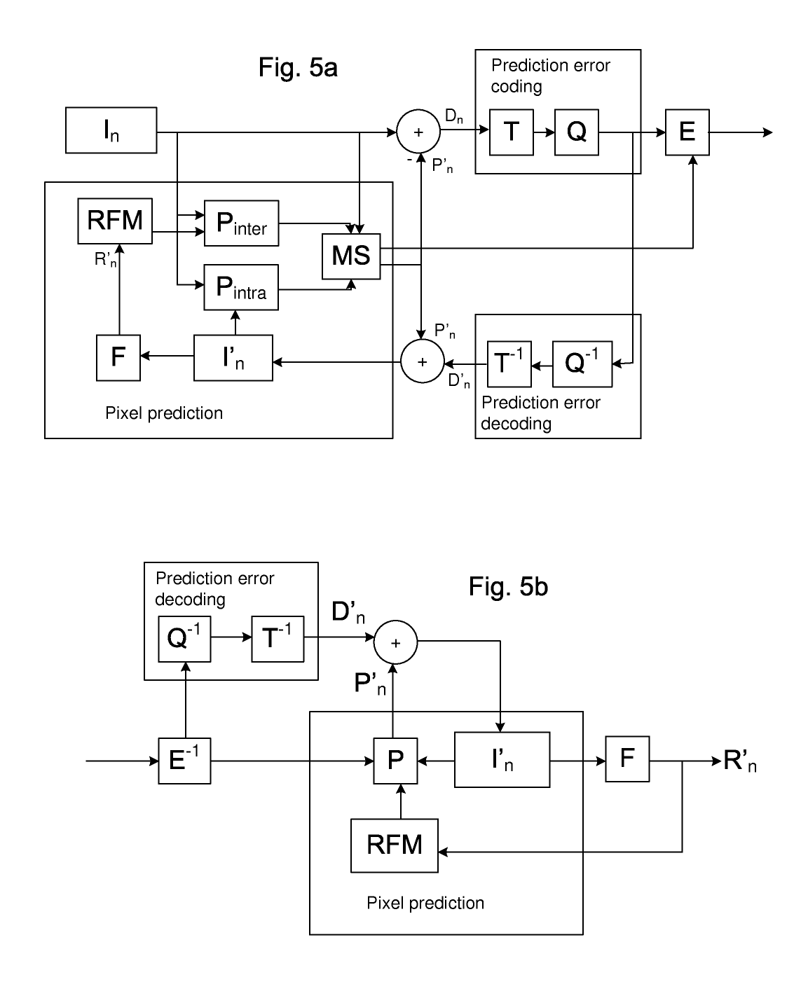

An example of an encoding process is illustrated in FIG. 5a. FIG. 5a illustrates an image to be encoded (Iₙ); a predicted representation of an image block (P′ₙ); a prediction error signal (Dₙ); a reconstructed prediction error signal (D′n); a preliminary reconstructed image (I′ₙ); a final reconstructed image (R′ₙ); a transform (T) and inverse transform (T⁻¹); a quantization (Q) and inverse quantization (Q⁻¹); entropy encoding (E); a reference frame memory (RFM); inter prediction (Pᵢₙₜₑᵣ); intra prediction (Pᵢₙₜᵣₐ); mode selection (MS) and filtering (F). An example of a decoding process is illustrated in FIG. 5b. FIG. 5b illustrates a predicted representation of an image block (P′ₙ); a reconstructed prediction error signal (D′ₙ); a preliminary reconstructed image (I′ₙ); a final reconstructed image (R′ₙ); an inverse transform (T⁻¹); an inverse quantization (Q⁻¹); an entropy decoding (E⁻¹); a reference frame memory (RFM); a prediction (either inter or intra) (P); and filtering (F).

The apparatus 50 may further comprise a card reader 48 and a smart card 46, for example a UICC (Universal Integrated Circuit Card) and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The 30 apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The various embodiments of the invention can be implemented with the help of computer program code that resides in a memory and causes the relevant apparatuses to carry out the invention. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving and transmitting data, computer program code in a memory, and a processor that, when running the computer program code, causes the network device to carry out the features of an embodiment.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-20. (canceled)

21. A method, comprising:
receiving media content from a multicamera capturing device, the media content comprising stereoscopic and monoscopic areas;
determining a plurality of preliminary most probable viewing directions from the received media content;
creating an ordered list of the plurality of preliminary most probable viewing directions;
determining a highest ranked preliminary most probable viewing direction in the ordered list of the plurality of preliminary most probable viewing directions that is in the stereoscopic area; and
setting such preliminary most probable viewing direction to be a final most probable viewing direction.

22. The method according to claim 21, wherein determining the highest ranked preliminary most probable viewing direction that is in the stereoscopic area comprises:
setting a top ranked preliminary most probable viewing direction to be a current most probable viewing direction;
determining whether the current most probable viewing direction is in the stereoscopic area; and in case it is not in the stereoscopic area
setting next ranked preliminary most probable viewing direction in the list to be the current most probable viewing direction, and performing the determining whether the current most probable viewing direction is in the stereoscopic area once more.

23. The method according to claim 21, wherein the preliminary most probable viewing directions are determined based on one or more of the following: direction of eye gazes, user inputs, or content provider inputs.

24. The method according to claim 21, wherein the ordered list of the plurality of preliminary most probable viewing directions comprises updated most probable viewing directions.

25. The method according to the claim 24, wherein the updated most probable viewing directions are determined using information on a direction of the multicamera capturing device.

26. The method according to claim 21, wherein the stereoscopic area is covered at least by two cameras of the multicamera capturing device.

27. An apparatus comprising at least one processor, memory including computer program code, the memory and the computer program code configured to, with the at least one processor, cause the apparatus to perform at least the following:
to receive media content from a multicamera capturing device, the media content comprising stereoscopic and monoscopic areas;
to determine a plurality of preliminary most probable viewing directions from the received media content;
to create an ordered list of the plurality of preliminary most probable viewing directions;
to determine a highest ranked preliminary most probable viewing direction in the ordered list of the plurality of preliminary most probable viewing directions that is in the stereoscopic area; and
to set such preliminary most probable viewing direction to be a final most probable viewing direction.

28. The apparatus according to claim 27, further comprising computer program code configured to cause the apparatus to determine the highest ranked preliminary most probable viewing direction that is in the stereoscopic area by
setting a top ranked preliminary most probable viewing direction to be a current most probable viewing direction;
determining whether the current most probable viewing direction is in the stereoscopic area; and in case it is not in the stereoscopic area,
setting next ranked preliminary most probable viewing direction in the list to be the current most probable viewing direction, and performing the determining whether the current most probable viewing direction is the stereoscopic area once more.

29. The apparatus according to claim 27, wherein the preliminary most probable viewing directions are determined based on one or more of the following: direction of eye gazes, user inputs, or content provider inputs.

30. The apparatus according to claim 27, wherein the ordered list of the plurality of preliminary most probable viewing directions comprises updated most probable viewing directions.

31. The apparatus according to the claim 30, wherein to determine the updated most probable viewing directions, the apparatus is further caused to use information on a direction of the multicamera capturing device.

32. The apparatus according to claim 27, wherein the stereoscopic area is covered at least by two cameras of the multicamera capturing device.

33. An apparatus comprising:
means for receiving media content from a multicamera capturing device, the media content comprising stereoscopic and monoscopic areas;
means for determining a plurality of preliminary most probable viewing directions from the received media content;
means for creating an ordered list of the plurality of preliminary most probable viewing directions;
means for determining a highest ranked preliminary most probable viewing direction in the ordered list of the plurality of preliminary most probable viewing directions that is in the stereoscopic area; and
means for setting such preliminary most probable viewing direction to be a final most probable viewing direction.

34. The apparatus according to claim 33, further comprising means for determining the highest ranked preliminary most probable viewing direction that is in the stereoscopic area by
setting a top ranked preliminary most probable viewing direction to be a current most probable viewing direction;
determining whether the current most probable viewing direction is in the stereoscopic area; and in case it is not in the stereoscopic area,
setting next ranked preliminary most probable viewing direction in the list to be the current most probable viewing direction, and performing the determining whether the current most probable viewing direction is the stereoscopic area once more.

35. The apparatus according to claim 33, wherein the ordered list of the plurality of preliminary most probable viewing directions comprises updated most probable viewing directions.

36. The apparatus according to the claim 35, further comprising means for determining the updated most probable viewing directions using information on a direction of the multicamera capturing device.

37. A computer program product embodied on a non-transitory computer readable medium, comprising computer program code configured to, when executed on at least one processor, cause an apparatus or a system to:
receive media content from a multicamera capturing device, the media content comprising stereoscopic and monoscopic areas;
determine a plurality of preliminary most probable viewing directions from the received media content;
create an ordered list of the plurality of preliminary most probable viewing directions;
determine a highest ranked preliminary most probable viewing direction in the ordered list of the plurality of preliminary most probable viewing directions that is in the stereoscopic area; and
set such preliminary most probable viewing direction to be a final most probable viewing direction.

38. The computer program product according to claim 37, further comprising computer program code configured to determine the highest ranked preliminary most probable viewing direction that is in the stereoscopic area by
setting a top ranked preliminary most probable viewing direction to be a current most probable viewing direction;
determining whether the current most probable viewing direction is in the stereoscopic area; and n case it is not in the stereoscopic area,
setting next ranked preliminary most probable viewing direction in the list to be the current most probable viewing direction, and performing the determining whether the current most probable viewing direction is the stereoscopic area once more.

39. The computer program product according to claim 37, wherein the ordered list of the plurality of preliminary most probable viewing directions comprises updated most probable viewing directions.

40. The computer program product according to the claim 39, further comprising computer program code configured to determine the updated most probable viewing directions using information on a direction of the multicamera capturing device.
